(19) United States
(12) Patent Application Publication
(10) Pub. No.: US 2015/0143512 A1
(43) Pub. Date: May 21, 2015

(54) IRIS KEY, SYSTEM AND METHOD OF UNLOCKING ELECTRONIC DEVICE USING THE IRIS KEY

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: MIN YANG, Wuhan (CN); XIN-SHU WANG, Wuhan (CN); JIAN-HUNG HUNG, New Taipei (TW)

(21) Appl. No.: 14/548,600

(22) Filed: Nov. 20, 2014

(30) Foreign Application Priority Data
Nov. 20, 2013 (CN) 201310587527.4

(51) Int. Cl. G06F 21/32

(52) U.S. Cl. CPC G06F 21/32
USPC 726/19

(57) ABSTRACT

In a method of unlocking an electronic device using an iris key, the iris key transmits an iris signal of a current user to the electronic device. The electronic device reads one or more pre-stored iris signal templates, and compares the received iris signal with the one or more iris signal templates. When the received iris signal matches with one of the one or more iris signal templates, the electronic device can be unlocked.

### CROSS-REFERENCE TO RELATED APPLICATIONS

This application claims priority to Chinese Patent Application No. 201310587527.4 filed on Nov. 20, 2013, the contents of which are incorporated by reference herein.

### FIELD

The present disclosure relates to electronic device unlocking technology, and particularly to an iris key, a system and method of unlocking an electronic device using the iris key.

### BACKGROUND

An electronic device (for example, a computer or a mobile phone) or a system may be locked for data security. Usually, a user can enter a valid password to unlock the electronic device or the system. The password can include letters, characters, alphanumeric characters, written characters, and symbols. Such passwords are easily to be stolen.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of an iris key.

FIG. 2 illustrates a block diagram of an example embodiment of an electronic device.

FIG. 3 illustrates a block diagram of an example embodiment of function modules of an unlocking system of the electronic device in FIG. 2.

FIG. 4 is a flowchart of an example embodiment of a method of unlocking an electronic device using an iris key.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

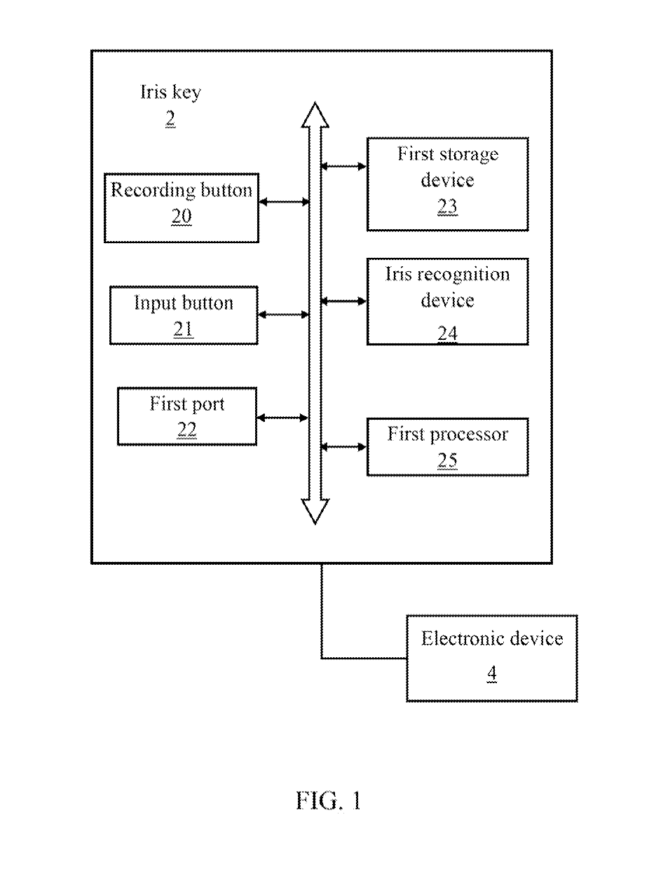

FIG. 1 illustrates a block diagram of an example embodiment of an iris key. In at least one embodiment, the iris key 2 includes components, such as, a recording button 20, an input button 21, a first port 22, a first storage device 23, an iris recognition device 24, and a first processor 25. The components 20-25 communicate with each other through system management bus (SMBus). It may be understood that, FIG. 1 illustrates only one example of the iris key 2, and other examples can include more or fewer components than those shown in the embodiment, or have a different configuration of the various components.

The recording button 20 can trigger records of one or more iris signal templates. Each of the iris signal templates include an iris signal of an authorized user. The authorized user is able to access a system or an electronic device, such as an electronic device 4. The electronic device 4 is connected to the iris key 2 via the first port 22 of the iris key 2. The first port 22 of the iris key 2 may be a communication (COM) port or a Universal Serial Bus (USB) port. In at least one embodiment, when the recording button 20 is selected, including being pressed or being touched, a record of an iris signal template is triggered. In at least one embodiment, when the record of an iris signal template is triggered, the iris recognition device 24 can recognize an iris signal of an authorized user and record the iris signal to generate the iris signal template.

The input button 21 can trigger an unlocking operation of the electronic device 4. In at least one embodiment, when the input button 21 is selected, including being pressed or being touched, the unlocking operation of the electronic device 4 is triggered, and the iris recognition device 24 can recognize an iris signal of a current user.

In at least one embodiment, the first storage device 23 can include an internal storage system, such as a flash memory, a random access memory (RAM) for temporary storage of information, and/or a read-only memory (ROM) for permanent storage of information. The first storage device 23 can also include an external storage system, such as an external hard disk, a storage card, or a data storage medium.

In at least one embodiment, the first processor 25 can include a central processing unit (CPU), a microprocessor, or other data processing chip that can perform various functions of the iris key 2. The first processor 25 can execute an analog-to-digital conversion to the iris signal recorded by the iris recognition device 24, encrypt the iris signal, then generate the iris signal template using the encrypted iris signal, and store the iris signal template into the first storage device 23.

The iris recognition device 24 can apply mathematical pattern-recognition techniques to images of irises of the user, whose complex random patterns are unique and can be seen from some distance, to recognize the iris signals, and transmit the iris signals to the second processor 45 of the electronic device 4, and/or the first processor 25 of the iris key 2.

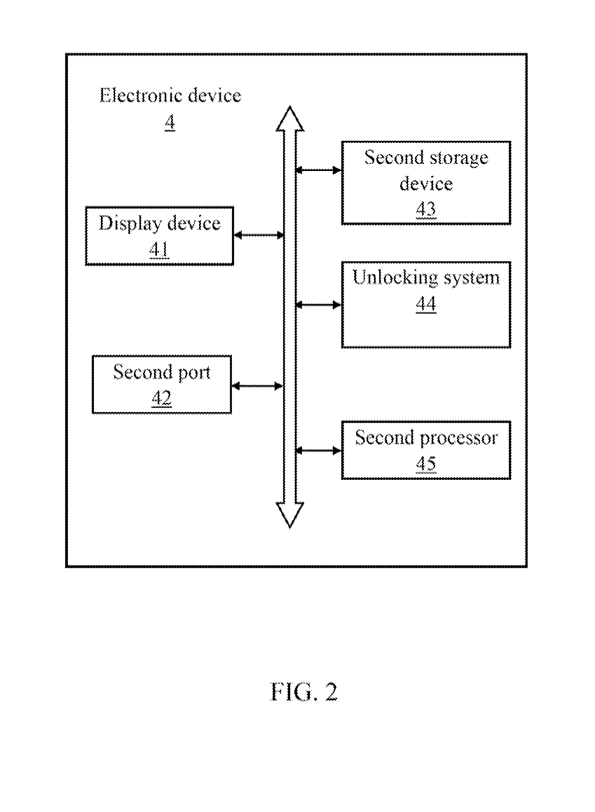

FIG. 2 illustrates a block diagram of an example embodiment of the electronic device which is connected to the iris key in FIG. 1. The electronic device 4 may be a smart phone, a computer, a smart television, and so on. In at least one embodiment, the electronic device 4 includes components, such as, a display device 41, a second port 42, a second storage device 43, an unlocking system 44, and a second processor 45. The components 41-45 communicate with each other through system management bus (SMBus). It may be understood that, FIG. 2 illustrates only one example of the electronic device 4, and other examples can include more or fewer components than those shown in the embodiment, or have a different configuration of the various components.

The display device 41 can output visible data. The second port 42 may be a COM port, or a USB port, and can be connected to the first port 22 of the iris key 2. The second port 42 can enable communications between the iris key 2 and the electronic device 4.

In at least one embodiment, the second storage device 43 can include an internal storage system, such as a flash memory, a random access memory (RAM) for temporary storage of information, and/or a read-only memory (ROM) for permanent storage of information. The second storage device 43 can also include an external storage system, such as an external hard disk, a storage card, or a data storage medium.

In at least one embodiment, the second processor 45 can include a central processing unit (CPU), a microprocessor, or other data processing chip that can perform various functions of the electronic device 4. The second processor 45 can also execute an analog-to-digital conversion to the iris signal of the authorized users transmitted by the iris key 2, encrypt the iris signal, generate the iris signal template using the encrypted iris signal, and store the iris signal template into the second storage device 4.

The unlocking system 44 can execute an unlocking operation to the electronic device 4 when the input button 21 of the iris key 2 is pressed or touched. In at least one embodiment, the unlocking operation of the electronic device 4 may include turning on or awaking up the electronic device 4.

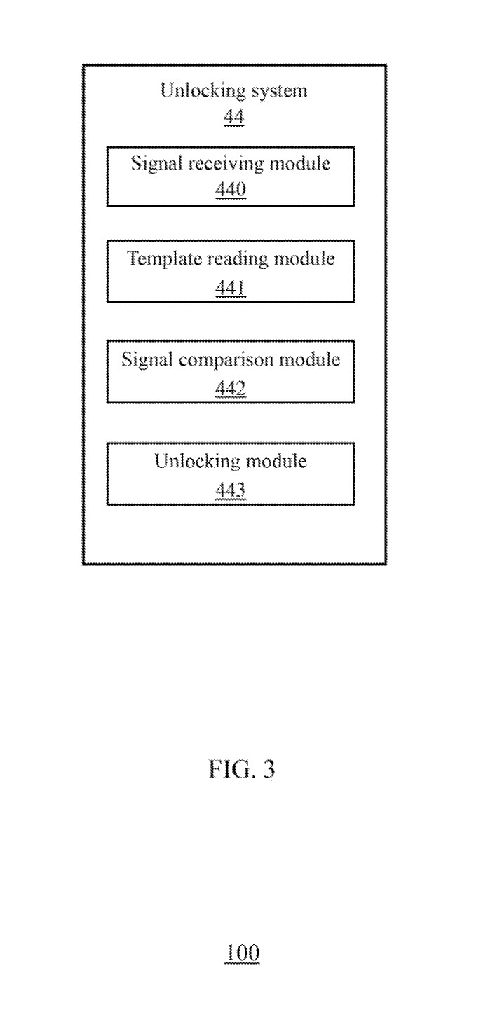

FIG. 3 illustrates a block diagram of an example embodiment of function modules of an unlocking system of the electronic device in FIG. 2. The function modules can include a signal receiving module 440, a template reading module 441, a signal comparison module 442, and an unlocking module 443.

The signal receiving module 440 can receive an iris signal transmitted from the iris key 2. When the iris key 2 and the electronic device 4 are connected to each other and the input button 21 of the iris key 2 is pressed or touched, the iris recognition device 24 of the iris key 2 can recognize an iris signal of a current user, and transmit the iris signal to the electronic device 4.

The template reading module 441 can read one or more pre-stored iris signal templates from the second storage device 43 of the electronic device 4.

The signal comparison module 442 can compare the received iris signal with the one or more iris signal templates. In at least one embodiment, the signal comparison module 442 can decrypt the one or more iris signal templates, and compare the received iris signal with the decrypted iris signal templates.

The unlocking module 443 can unlock the electronic device 4 when the received iris signal matches with one of the one or more iris signal templates. In at least one embodiment, the unlocking module 443 can turn on or awake up the electronic device 4.

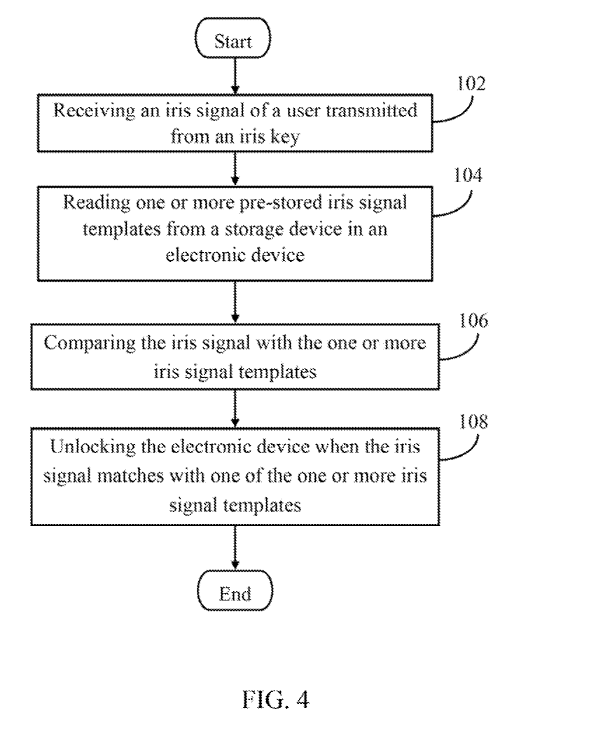

FIG. 4 is a flowchart of an example embodiment of a method of unlocking an electronic device using an iris key. Referring to FIG. 4, a flowchart is presented in accordance with an example embodiment illustrated. The example method 100 is provided by way of example, as there are a variety of ways to carry out the method 100. The method 100 described below can be carried out using the configurations illustrated in FIGS. 1 to 3, for example, and various elements of these figures are referenced in explaining example method 100. Each block shown in FIG. 4 represents one or more processes, methods or subroutines, carried out in the exemplary method 100. Furthermore, the illustrated order of blocks is by example only and the order of the blocks can change according to the present disclosure. Additional blocks may be added or fewer blocks may be utilized, without departing from this disclosure. The exemplary method 100 can begin at block 102.

At block 102, a signal receiving module of an electronic device receives an iris signal transmitted from an iris key that is connected to the electronic device. When the iris key and the electronic device are connected to each other and an input button of the iris key is selected, including being pressed or being touched, for example, an iris recognition device of the iris key recognizes an iris signal of a current user, and transmits the iris signal to the electronic device.

At block 104, a template reading module of the electronic device reads one or more pre-stored iris signal templates from a second storage device of the electronic device. Each of the iris signal templates include an iris signal of an authorized user. The authorized user is permitted to access the electronic device. In at least one embodiment, a recording button of the iris key can trigger records of one or more iris signal templates. When the recording button is pressed or touched, a record of an iris signal template is triggered, and an iris recognition device of the iris key recognizes an iris signal of an authorized user and records the iris signal to generate the iris signal template.

At block 106, a signal comparison module of the electronic device compares the received iris signal with the one or more iris signal templates. In at least one embodiment, when the one or more iris signal templates are encrypted, the signal comparison module decrypts the one or more iris signal templates, and compares the received iris signal with the decrypted iris signal templates.

At block 108, an unlocking module of the electronic device unlocks the electronic device when the received iris signal matches with one of the one or more iris signal templates. In at least one embodiment, the unlocking module can turn on or awake up the electronic device.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An iris key comprising:
an input button; and
an iris recognition device configured to, upon selection of the input button, recognize an iris signal of a current user and transmit the iris signal to an electronic device that is connected to the iris key.

2. The iris key according to claim 1, further comprising:
a storage device;
a processor; and
a recording button, when being selected to trigger a record of an iris signal template, the record comprising:
recognizing an iris signal of an authorized user using the iris recognition device, recording the iris signal of the authorized user, and transmitting the iris signal of the authorized user to the processor; and
executing an analog-to-digital conversion to the iris signal of the authorized user using the processor, generating the iris signal template using the iris signal of the authorized user, and storing the iris signal template into the storage device.

3. The iris key according to claim 1, wherein the iris key comprises a first port that connects to the electronic device.

4. The iris key according to claim 3, wherein the first port is a communication (COM) port or a Universal Serial Bus (USB) port.

5. An electronic device, the electronic device connecting to an iris key, wherein the electronic device comprises:
a storage device;
a processor, which receives iris signals of authorized users from the iris key, executes an analog-to-digital conversion to the iris signals of the authorized users, generates one or more iris signal templates using the iris signals, and stores the one or more iris signal templates into the storage device; and
an unlocking system that compares an iris signal of a current user transmitted from the iris key with the one or more iris signal templates, and unlocks the electronic device when the received iris signal matches with one of the one or more iris signal templates.

6. The electronic device according to claim 5, further comprising a second port that connects to the iris key.

7. The electronic device according to claim 6, wherein the second port is a communication (COM) port or a Universal Serial Bus (USB) port.

8. A method of unlocking an electronic device using an iris key, comprising:
receiving an iris signal of a current user transmitted from the iris key;
reading one or more pre-stored iris signal templates;
comparing the received iris signal with the one or more iris signal templates; and
unlocking the electronic device when the received iris signal matches with one of the one or more iris signal templates.

9. The method according to claim 8, wherein the one or more pre-stored iris signal templates are generated by:
selecting a recording button of the iris key to trigger a record of an iris signal template; and
recognizing an iris signal of an authorized user by an iris recognition device of the iris key, and recording the iris signal to generate the iris signal template.

10. The method according to claim 8, wherein the iris signal of the current user is generated by:
selecting an input button of the iris key; and
recognizing an iris signal of the current user by an iris recognition device of the iris key, and transmitting the iris signal to the electronic device.

11. The method according to claim 8, wherein the unlocking of the electronic device comprising turning on or awaking up of the electronic device.
